(19) United States
(12) Patent Application Publication
(10) Pub. No.: US 2006/0282406 A1
(43) Pub. Date: Dec. 14, 2006

(54) METHOD AND APPARATUS FOR SEARCHING DATA

(76) Inventor: Tzu-Ping Jan, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/422,334

(22) Filed: Jun. 6, 2006

(30) Foreign Application Priority Data
Jun. 10, 2005 (TW) 094119166

(51) Int. Cl. G06F 17/30

(52) U.S. Cl. 707/2

(57) ABSTRACT

Methods and apparatus for searching a plurality of data are disclosed. Each of the plurality of data includes consecutive segments of a first data segment, a delimiter segment, and a second data segment, wherein the delimiter segment includes at least one delimiter. One of the disclosed data search methods includes: receiving an input value sequence comprising at least a first and a second input value; and selecting at least one target data, whose first and second data segments respectively correspond to the first and the second input values, from the plurality of data.

### BACKGROUND OF THE INVENTION

1. Field of the Invention

The present invention relates to methods and apparatuses for searching data, and more particularly, to methods and apparatuses for searching data that contains delimiters.

2. Description of the Prior Art

The progress of technologies and manufacturing processes enrich the functionalities of many digital or electronic apparatuses and make these apparatuses become lighter, smaller, and portable. For many people, the portable device such as the mobile phone or personal digital assistant (PDA) plays a very important role in their life or work.

In order to satisfy the demand of life or work, the user often records many data in the mobile phone or PDA, such as the names, addresses, email addresses, phone numbers of friends, family members, or clients, and even the favorite website addresses, etc. When the user wants to search one or multiple data from those data stored in the mobile phone or PDA, one conventional method is to utilize the selection keys to sift those data entry by entry. However, the data searching efficiency of this method is not desirable, especially if there is a considerable amount of data being stored therein.

Another conventional searching method is that the user inputs the leading characters of data to be searched and then the system sifts data from a database or storage unit according to the character sequence inputted by the user. For example, if the user firstly inputs a character “a”, the system selects data whose leading character is the character “a” from the database or storage unit. If the next character the user inputs is the character “s”, the system sifts data whose second character is the character “s” from those data leading with character “a”. Subsequently, if the following character the user input is the character “u”, the system sifts data whose third character is the character “u” from those data leading with the string “as”. In this way, the amount of data matching the searching condition gradually reduces with the increase of characters inputted by the user. Finally, the user is able to find the desired data from a few data matching the input sequence.

Unfortunately, in order to minimize the required space, the control pad or input interface of the conventional mobile phone or PDA is usually designed to be as simple as possible unlike a related large number of keys are arranged in the computer's keyboard. Therefore, the user can only use a limited number of keys to input the leading strings of data to be searched. Obviously, such data searching method is not convenient in practical applications. In view of the foregoing, it can be appreciated that the data searching performance and convenience of utilization of the prior art need to be improved.

### SUMMARY OF THE INVENTION

It is therefore an objective of the claimed invention to provide data searching methods and related apparatuses to solve the above-mentioned problems.

According to an exemplary embodiment, a data searching device is disclosed comprising: an input module; a storage unit for storing a plurality of data, each data comprising consecutive segments of a first data segment, a delimiter segment, and a second data segment; and a search module coupled to the storage unit for receiving an input value sequence comprising at least a first and a second input value from the input module, and for selecting at least one target data, whose first and second data segments respectively correspond to the first and second input values, from the plurality of data; wherein the delimiter segment includes at least one delimiter.

According to an exemplary embodiment, a data searching method is disclosed comprising: storing a plurality of data, each data comprising consecutive segments of a first data segment, a delimiter segment, and a second data segment, wherein the delimiter segment includes at least one delimiter; receiving an input value sequence comprising at least a first and a second input value; and selecting at least one target data, whose first and second data segments respectively correspond to the first and the second input values, from the plurality of data.

Additionally, a data searching method for selecting at least a target data from a plurality of data is also disclosed. Each of the plurality of data includes a plurality of data segments interlaced with a plurality of delimiter segments in which each delimiter segment includes at least one delimiter. The data searching method comprises: receiving K input values; and selecting data from the plurality of data to be the target data in which leading characters of the first K data segments of the selected data correspond to the K input values, respectively.

Thereto, a machine readable medium is disclosed. The machine readable medium contains executable program code, which when executed by a processor cause the processor to perform a data searching method for selecting at least a target data from a plurality of data, each of the plurality of data comprising a plurality of data segments interlaced with a plurality of delimiter segments where each delimiter segment includes at least one delimiter; and the data searching method includes: receiving K input values; and selecting data from the plurality of data to be the target data in which leading characters of the first K data segments of the selected data correspond to the K input values, respectively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a data searching device according to an exemplary embodiment.

FIG. 2 is a flowchart illustrating a data searching method according to an exemplary embodiment.

FIG. 3 is a schematic diagram of a bookmark stored in a storage unit of FIG. 1 according to one embodiment.

### DETAILED DESCRIPTION

In general, many data stored in the portable device (e.g., the mobile phone or PDA) by the user are strings composed of character such as English letters, double-byte characters, numbers, or symbols. These data encompass the names, addresses, email addresses, phone numbers of friends, family members, or clients, and the favorite website addresses, etc. Typically, each of these strings often includes at least one delimiter, such as “_”, “-”, “@”, “.”, “,”, “(blank space)”, or any other symbol. For the purpose of explanatory convenience in the following description, all characters other than the letters, double-byte characters, and numbers are classified into delimiters. For example, an email address “email@test.com” includes two delimiters: “@” and “.”, while a website address “http://www.uspto.gov/” includes six delimiters: one “:”, three “/”, and two “.”.

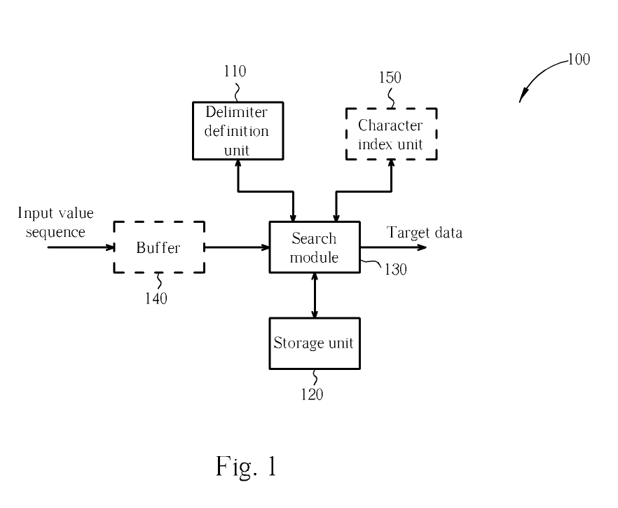

Please refer to FIG. 1, which shows a block diagram of a data searching device 100 according to an exemplary embodiment. As shown, the data searching device 100 of this embodiment includes a delimiter definition unit 110, a storage unit 120, and a search module 130. The operations and implementations of each functional block of the data searching device 100 are described below.

The delimiter definition unit 110 is arranged for defining delimiters. As mentioned previously, all characters other than the letters, double-byte characters, and numbers are classified into delimiters in this embodiment. Note that the definition of delimiters can be adjusted according to the design choice and is not necessarily subject to the above example. In practice, the delimiter definition unit 110 may be implemented in hardware or software techniques. For example, the delimiter definition unit 110 may be a register stored with a plurality of delimiter definitions. Thereto, the delimiter definition unit 110 may be a declaration section of a program code stored in a memory.

The storage unit 120 is arranged for storing a plurality of data inputted or loaded by the user, such as the email addresses, addresses, website addresses, names, or phone numbers, etc. In practice, the storage unit 120 may be implemented in any form such as a memory, a FLASH card, a hard disk drive, an optical storage medium, and so on. In this embodiment, each of the plurality of data includes at least a delimiter segment and multiple data segments, wherein each data segment includes at least one non-delimiter character while each delimiter segment includes at least one delimiter. For example, the foregoing email address “email@test.com” includes a first data segment “email”, a first delimiter segment “@”, a second data segment “test”, a second delimiter segment “.”, and a third data segment “com”. The website address “http://www.uspto.gov/” includes a first data segment “http”, a first delimiter segment “://”, a second data segment “www”, a second delimiter segment “.”, a third data segment “uspto”, a third delimiter segment “.”, a fourth data segment “gov”, and a fourth delimiter segment “/”.

As can be seen from the above examples, pluralities of data segments in a data are interlaced with a plurality of delimiter segments in the data. The number and type of delimiters of each data may differ from one another.

In this embodiment, the search module 130, such as a processor, selects at least one target data from the plurality of data stored in the storage unit 120 according to an input value sequence from an input module (not shown). In practical applications, the input module may vary with the type of the data searching device 100. For instance, if the data searching device 100 is a mobile phone, the input module is typically the key pad of the mobile phone. If the data searching device 100 is a PDA, the input module may be the touch panel of the PDA. Additionally, the input module may be other interfaces in which the user can input data therethrough. For example, the input module may be a keyboard, a handwriting board, or a voice control module for supporting the user to control the data searching device 100 through vocal commands. As shown in FIG. 1, a buffer 140 is usually arranged between the search module 130 and the input module for buffering the input value sequence from the input module.

In practice, the format of the input value sequence from the input module may vary with the type of the input module. For example, if the input module is a touch panel, each input value of the input value sequence usually corresponds to a single character. If the input module is the key pad of a mobile phone, then each input value of the input value sequence may correspond to more than one character. For instance, key “2” of the key pad of the mobile phone corresponds to characters “a”, “b”, and “c” while key “7” corresponds to characters “p”, “q”, “r”, and “s”. In this kind of applications, a character index unit 150 is also employed in the data searching device 100 for recording at least one corresponding character of each input value. When the search module 130 receives an input value, the search module 130 is able to convert the input value into at least one corresponding character according to the content recorded in the character index unit 150.

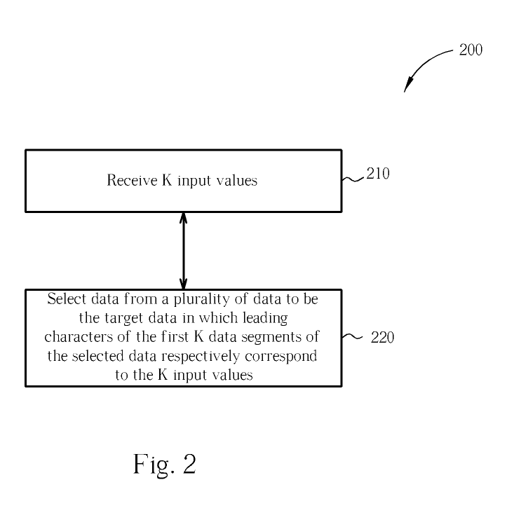

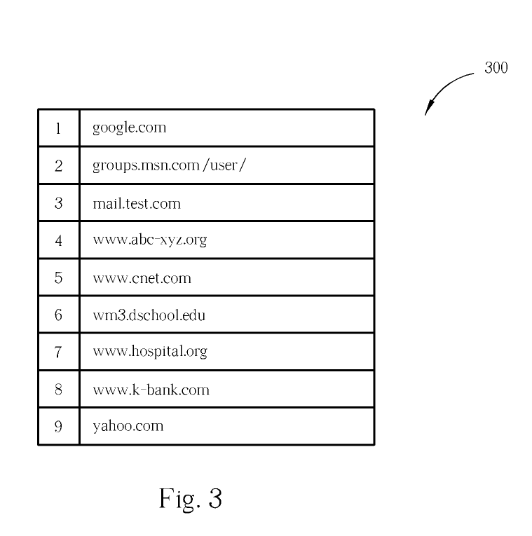

Please refer to FIG. 2, which shows a flowchart 200 illustrating a data searching method according to an exemplary embodiment. Hereinafter, the operations of the search module 130 will be explained in detail with reference to the flowchart 200. For the purpose of explanatory convenience in the following description, it is assumed that the data searching device 100 is a mobile phone and a bookmark 300 that includes nine website addresses as shown in FIG. 3 is stored in the storage unit 120.

In step 210, the search module 130 receives an input value sequence including K input values from the input module through the buffer 140.

In step 220, the search module 130 selects data from the bookmark 300 stored in the storage unit 120 in which the leading characters of the first K data segments of the selected data match the K input values, respectively.

Since the data searching device 100 is assumed as a mobile phone in this embodiment, the search module 130 converts each of the K input values into at least one corresponding target character according to the content recorded in the character index unit 150 in step 220. The search module 130 then selects at least one target data from the bookmark 300 in which the leading characters of the first K data segments of the target data match the corresponding target characters, respectively.

It should be noted that the execution order of the steps 210 and 220 is merely an embodiment rather than a restriction of the practical implementations.

In a preferred embodiment, the steps 210 and 220 are performed simultaneously. For example, when the first input value of the input value sequence received by the search module 130 is “9”, the search module 130 converts the first input value “9” into at least one target character according to the content recorded in the character index unit 150. In this embodiment, characters corresponding to the first input value “9” are “w”, “x”, “y”, and “z”. Accordingly, the search module 130 selects data whose leading character (i.e., the first character) of the first data segment is the character “w”, “x”, “y”, or “z” from the bookmark 300. After comparison, the search module 130 obtains six candidate website addresses: “www.abc-xyz.org”, “www.cnet.com”, “wm3.dschool.edu”, “www.hospital.org”, “www.k-bank.com”, and “yahoo.com”.

If the next input value, i.e., the second input value of the input value sequence, received by the search module 130 is “2”, the search module 130 looks up characters corresponding to the input value “2” from the character index unit 150. In this embodiment, the search module 130 obtains the characters “a”, “b”, and “c”. Subsequently, the search module 130 selects data whose leading character of the second data segment is the character “a”, “b”, or “c” from the candidate website addresses. In this case, three website addresses, “www.abc-xyz.org”, “www.cnet.com”, and “yahoo.com”, are selected as the candidate website addresses for next run.

Suppose that the following input value, i.e. the third input value of the input value sequence, received by the search module 130 is also “2”, the search module 130 selects data whose leading character of the third data segment is the character “a”, “b”, or “c” from the candidate website addresses obtained in the previous run. In this example, only one website address “www.cnet.com” matches the above searching condition so that it is selected by the search module 130. This is, if the user sequentially presses the keys “9”, “2”, “2” of the mobile phone in this embodiment, the search module 130 performs the foregoing searching operations to select the matched website address “www.cnet.com” from the bookmark 300.

According to the data searching method illustrated previously, when the user wants to get the complete string of the website address “groups.msn.com/user/”, the user can press the key “4” and key “6” to obtain the desired result. In practice, the search module 130 may temporarily store the results of the current searching run into a buffer of memory stacks as the comparing target for use in next searching run. Alternatively, the searching results obtained by the search module 130 in each searching run may be provided on a displaying screen (not shown) so that the user can utilize the selection keys to choice a desired data from those shown on the displaying screen. Therefore, the disclosed data searching method may be employed to implement a smart data input function. For example, when the user wants to input a complete string that has recorded in the storage unit 120, the user only needs to press a few keys and the search module 130 is able to select one or few matched data from the storage unit 120 efficiently. Then, the user can easily complete the data input action by utilizing the selection keys to choice a string to be inputted.

In practical implementations, the disclosed data searching method can be properly programmed as executable program code and be stored in a machine readable medium, such as a non-volatile memory. Additionally, the search module 130 may be a processor. When the processor executes the executable program code stored in the machine readable medium, the processor performs the data searching method disclosed previously to select at least one corresponding target data from the plurality of data stored in the storage unit 120 according to an input value sequence. Those of ordinary skilled in the art can readily draft executable program code according to the foregoing descriptions, and further details of programming are therefore omitted for brevity.

Note that the data searching device 100 is assumed as a mobile phone in the foregoing descriptions. This is merely for the purpose of explanatory convenience rather than a restriction of the practical applications. In practice, the data searching device 100 may be a PDA, a computer, or any other electronic device capable of storing data and allowing the user to search data therefrom. For example, some digital videos (DVs) allow the user to input titles or remarks for video data recorded therein. The disclosed data searching method can be applied in such devices to improve the data searching efficiency and convenience of utilization. It can be appreciated by those skilled in the art that the character index unit 150 may be omitted in some applications, such as in the computer or PDA. In addition, different functional blocks may be combined or integrated in a single circuit or chip.

The concept of the delimiter-based data searching operations can also be employed in Internet applications. For example, the disclosed data searching method can be applied in the browser software to improve the searching efficiency for the website addresses recorded in the browsed history. Additionally, the application service provider (ASP) who provides the services of web-based mail or on-line memo can improve the searching efficiency and convenience of utilization in searching the email contact list, address list, names, bookmarks, phone books, etc, by employing the foregoing data searching method.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data searching device comprising:
an input module;
a storage unit for storing a plurality of data, each data comprising consecutive segments of a first data segment, a delimiter segment, and a second data segment; and
a search module coupled to the storage unit for receiving an input value sequence comprising at least a first or a second input value from the input module, and for selecting at least one target data, whose first and second data segments respectively correspond to the first or second input values, from the plurality of data;
wherein the delimiter segment includes at least one delimiter.

2. The data searching device of claim 1, further comprising:
a buffer coupled to and disposed between the search module and the input module for buffering the input value sequence from the input module.

3. The data searching device of claim 1, further comprising:
a character index unit coupled to the search module for recording at least one target character corresponding to each input value of the input value sequence;
wherein the search module converts the first input value into at least one target character according to the recorded content in the character index unit and selects a plurality of candidate data from the plurality of data in which a first character of a first data segment of each candidate data matches the first target character, the search module further converts the second input value into at least one second target character and selects the target data from the plurality of candidate data in which a first character of a second data segment of the target data matches the second target character.

4. The data searching device of claim 1, wherein the search module selects a plurality of candidate data from the plurality of data in which a first character of a first data segment of each candidate data matches the first input value, and then selects the target data from the plurality of candidate data in which a first character of a second data segment of the target data matches the second input value.

5. The data searching device of claim 1, wherein the search module is a processor.

6. A data searching method comprising:
storing a plurality of data, each data comprising consecutive segments of a first data segment, a delimiter segment, and a second data segment, wherein the delimiter segment includes at least one delimiter;
receiving an input value sequence comprising at least a first and a second input value; and
selecting at least one target data, whose first and second data segments respectively correspond to the first and the second input values, from the plurality of data.

7. The data searching method of claim 6, wherein the step of selecting at least one target data further comprises:
converting the first input value into at least one first target character;
selecting a plurality of candidate data from the plurality of data in which a first character of a first data segment of each candidate data matches the first target character;
converting the second input value into at least one second target character; and
selecting the target data from the plurality of candidate data in which a first character of a second data segment of the target data matches the second target character.

8. The data searching method of claim 6, wherein the step of selecting at least one target data further comprises:
selecting a plurality of candidate data from the plurality of data in which a first character of a first data segment of each candidate data matches the first input value; and
selecting the target data from the plurality of candidate data in which a first character of a second data segment of the target data matches the second input value.

9. A data searching method for selecting at least a target data from a plurality of data, each of the plurality of data comprising a plurality of data segments interlaced with a plurality of delimiter segments in which each delimiter segment includes at least one delimiter; the data searching method comprising:
receiving K input values; and
selecting data from the plurality of data to be the target data in which leading characters of the first K data segments of the selected data correspond to the K input values, respectively.

10. The data searching method of claim 9, wherein the step of selecting data from the plurality of data to be the target data further comprises:
converting each of the K input values into at least one target character; and
selecting data from the plurality of data to be the target data in which the leading characters of the first K data segments of the selected data match the corresponding target characters, respectively.

11. A machine readable medium containing executable program code, which when executed by a processor cause the processor to perform a data searching method for selecting at least a target data from a plurality of data, each of the plurality of data comprising a plurality of data segments interlaced with a plurality of delimiter segments where each delimiter segment includes at least one delimiter; the data searching method comprising:
receiving K input values; and
selecting data from the plurality of data to be the target data in which leading characters of the first K data segments of the selected data correspond to the K input values, respectively.

12. The machine readable medium of claim 11, wherein the step of selecting data from the plurality of data to be the target data further comprises:
converting each of the K input values into at least one target character; and
selecting data from the plurality of data to be the target data in which the leading characters of the first K data segments of the selected data match corresponding target characters, respectively.
